(19) United States
(12) Patent Application Publication
(10) Pub. No.: US 2017/0297473 A1
(43) Pub. Date: Oct. 19, 2017

(54) Tarping Apparatus

(71) Applicant: Transport Safety Services, Grandville, MI (US)

(72) Inventors: Larry Baareman, Byron Center, MI (US); Mark Baareman, Hamilton, MI (US)

(21) Appl. No.: 15/130,935

(22) Filed: Apr. 16, 2016

(51) Int. Cl. B60P 7/04; B65H 75/42; B65H 75/44

(52) U.S. Cl. CPC B60P 7/04; B65H 75/4492; B65H 75/42; B65H 2701/1922

(57) ABSTRACT

A tarping apparatus including a base frame, a tarp support boom assembly and a drum member. The base frame includes an inner side and an outer side opposite the inner side. The tarp support boom assembly includes a boom member having a proximal end and a distal end. The proximal end is coupled to the base frame and the distal end extends outwardly therefrom beyond the inner side of the base frame. The drum member extends around the boom member and is rotatable about an axis defined by the boom member. The drum member includes a first end corresponding to the proximal end of the boom member and a second end corresponding to the distal end of the boom member. A tarp positioned over the drum member can be rolled up on the drum member through rotation of the drum member relative to the boom member.

### CROSS-REFERENCE TO RELATED APPLICATION

N/A

### BACKGROUND OF THE DISCLOSURE

### 1. Field of the Disclosure

The disclosure relates in general to tarping, and more particularly, to a tarping apparatus which is configured to assist with the application of a tarp over an outside structure, such as a flatbed of a semitrailer or the like. The use of the tarping apparatus is not limited to the covering of a flatbed of a semitrailer, and such is shown for illustrative purposes only.

### 2. Background Art

It is known to apply a tarp to outside structures. For example, once a flatbed of a trailer is loaded with materials, it is often desirable and/or necessary to apply a tarp over these materials. Typically, one or more users grasp a tarp and position it on top of the load. Next, they generally climb on the flatbed trailer and handle the tarp. In particular, they unravel the tarp and manipulate it so as to cover the materials. Once the tarp covers the materials, the tarp can be attached to the flatbed trailer along the outside perimeter thereof.

Problematically, it is often necessary to climb on the load which may be elevated off the ground, and off the flatbed surface. In addition, the load may be uneven and difficult to stand on and traverse. Thus, the surface may be dangerous for a user to be climbing and traversing. As a result, many individuals are injured each year climbing and traversing across a load on a flatbed so as to unroll and install a tarp thereover.

### SUMMARY OF THE DISCLOSURE

The disclosure is directed to a tarping apparatus comprising a base frame, a tarp support boom assembly and a drum member. The base frame includes an inner side and an outer side opposite the inner side. The tarp support boom assembly includes a boom member having a proximal end and a distal end. The proximal end is coupled to the base frame and the distal end extends outwardly therefrom beyond the inner side of the base frame. The drum member extends around the boom member and is rotatable about an axis defined by the boom member. The drum member includes a first end corresponding to the proximal end of the boom member and a second end corresponding to the distal end of the boom member. A tarp positioned over the drum member can be rolled up on the drum member through rotation of the drum member relative to the boom member.

In some configurations, the base frame further defines at least two fork pockets each configured to receive a fork of a forklift, to in turn, facilitate the lifting thereof.

In some configurations, the at least two fork pockets are defined by a pair of at least one of lateral beams that are substantially parallel to each other and in a spaced apart configuration, and cross beams that are substantially parallel to each other and in a spaced apart configuration.

In some configurations, the cross beams and the lateral beams are substantially perpendicular to each other.

In some configurations, the boom member extends outwardly and upwardly relative to the base frame so that the proximal end is positioned lower than the distal end of the boom member.

In some configurations, the base frame has a top surface defining a plane, with the boom member angled relative to the plane defined by the top surface of the base frame at an angle of between approximately 1° and approximately 45°.

In some configurations, the tarp support boom assembly further includes a boom coupling member coupled to each of the boom member and the base frame. The boom member extends outwardly therefrom. The boom coupling member includes a deflecting surface extending proximate the inner side of the base frame. The deflecting surface is configured to direct a tarp onto the drum member, and away from the base frame.

In some configurations, the deflecting surface includes a front face from which the boom member extends, a first wing face extending to one side of the front face, and oblique thereto, and a second wing face extending to the other side of the front face, and oblique thereto.

In some configurations, the drum member includes a first end that corresponds to the proximal end of the boom member, and a second end that extends beyond the distal end of the boom member.

In some configurations, the tarp support boom assembly includes an outer support bearing surface positioned at the distal end of the boom member. The outer support bearing surface facilitates the rotation of the drum member relative to the boom member.

In some configurations, the tarping apparatus further includes a handle structure coupled to the second end of the drum member. The handle structure includes a moment arm a component of which extends substantially perpendicular to the drum member, and has an outer end. A handle is coupled to the outer end of the moment arm. Rotation of the handle member about the axis defined by the boom member rotates the drum member around the boom member.

In some configurations, the moment arm comprises a disk coupled to the second end of the drum member. The disk includes an inner surface and an outer surface, with an outer perimeter corresponding to the outer end. The handle is coupled to the outer perimeter of the moment arm.

In some configurations, the boom member has a substantially cylindrical configuration, with a substantially circular cross-sectional configuration.

In some configurations, the drum member has a substantially cylindrical configuration, with a substantially circular cross-sectional configuration.

In another aspect of the disclosure, the disclosure is directed to a method of tarping an outside structure such as a flatbed comprising the steps of: providing a tarping apparatus of the type set forth herein; providing a tarp having a proximal end and a distal end; positioning the proximal end of the tarp on the drum member; rotating the drum member so as to roll the tarp thereon until the distal end at least approaches the drum member; positioning the tarping apparatus relative to the outside structure, so that the drum member overlies the outside structure; retaining the distal end of the tarp proximate an end of the outside structure; directing the tarping assembly along the outside structure, with the drum member traversing the outside structure; and rotating the drum member to, in turn, unroll the tarp onto the outside structure.

In some configurations, the drum member is positioned so as to be substantially perpendicular to a direction of travel of the tarping apparatus.

In some configurations, the method of tarping further includes the steps of: providing a forklift; and coupling the base frame to a forklift.

In some configurations, the step of positioning the tarping apparatus relative to the outside structure further comprises the step of: moving the forklift to a location proximate the outside structure.

In some configurations, the step of directing the tarping assembly along the outside structure further comprises the step of: moving the forklift relative to the outside structure.

### BRIEF DESCRIPTION OF THE DRAWINGS

The disclosure will now be described with reference to the drawings wherein:

FIG. 1 of the drawings is a perspective view of the tarping apparatus of the present disclosure;

FIG. 2 of the drawings is a side elevational view of the tarping apparatus of the present disclosure;

FIG. 3 of the drawings is a top plan view of the tarping apparatus of the present disclosure;

FIG. 4 of the drawings is a perspective view of the tarping apparatus of the present disclosure coupled to a forklift and prior to the coupling of a tarp thereto;

FIG. 5 of the drawings is a perspective view of the placement, or rolling up, of the tarp onto the tarping apparatus of the present disclosure;

FIG. 6 of the drawings is a perspective view of the positioning of the tarping apparatus of the present disclosure in the proper orientation overlying an outside surface to initiate the unrolling of the tarp thereover;

FIG. 7 of the drawings is a perspective view of the continued unrolling of the tarp by the movement of the tarping apparatus along the outside surface, while retaining an end of the tarp; and

FIG. 8 of the drawings is a perspective view of the unrolled tarp over the outside surface, with the tarping assembly of the present disclosure positioned thereover, prior to moving the tarping assembly away from the outside surface.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

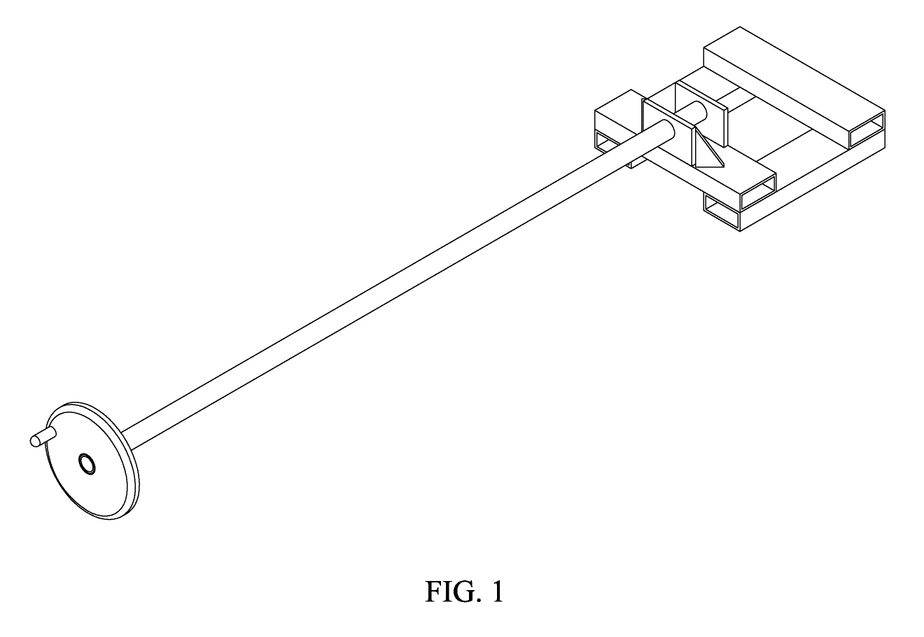

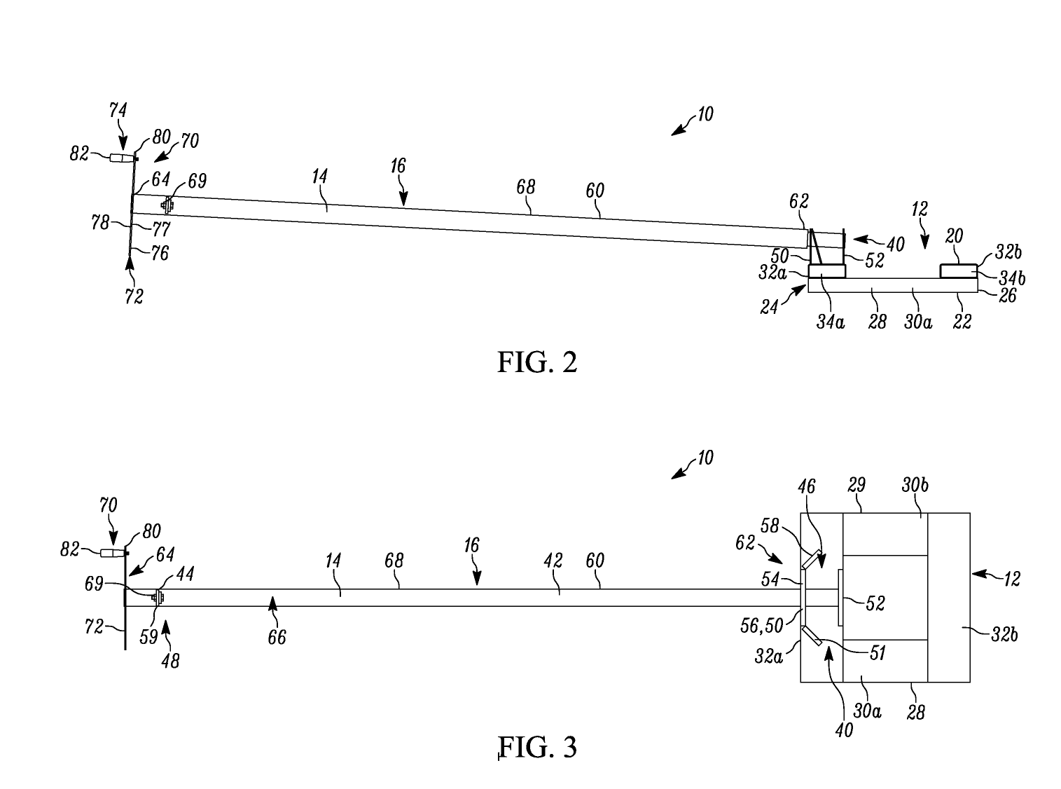

Referring now to the drawings and in particular to FIGS. 1 through 3, the tarping apparatus is shown generally at 10. The tarping apparatus is configured for unrolling a tarp over a flatbed semitrailer, or another outside structure. Generally, the tarping apparatus is configured to be attachable to a forklift or the like, with the forklift controlling the movement of the tarping apparatus relative to the semitrailer. Of course, the tarping apparatus may have other applications and may be handled by equipment other than a forklift or the like. It is contemplated that the tarping apparatus may be coupled to another piece of equipment (such as a powered cart, a lift, crane, UTV, among others). It is further contemplated that the tarping apparatus may be coupled to a frame that can be rolled or otherwise pushed along the side of the semitrailer. In still other configurations, the semitrailer may be moved, at the same time as the tarping apparatus is moved (in, for example, opposing directions), or while the tarping apparatus is maintained substantially stationary or in a fixed position.

In the configuration shown, and with continued reference to FIGS. 1 through 3, the tarping apparatus may include base frame 12, tarp support boom assembly 14 and tarp drum assembly 16. The base frame 12, in the configuration shown, is preferably coupled to a forklift or other equipment having forks or the like. The base frame 12 is defined by a top surface 20, a bottom surface 22 in a generally square or rectangular footprint, thereby defining an inner side 24, an outer side 26, and lateral sides 28, 29. The tarp support boom assembly extends from the inner side 24 of the base frame 12. In the configuration shown, the base frame 12 is formed from four rectangular beams, namely, lateral beams 30a, 30b and cross beams 32a, 32b. The lateral beams are generally parallel to each other and coplanar, with the cross beams being substantially parallel to each other and coplanar. The cross beams are generally perpendicular to the lateral beams with one being positioned over the other. The outer edges of the lateral beams form the lateral sides 28, 29 with the outer edges of the cross beams forming the inner and outer sides 26, 28. The spacing of both the lateral beams and the cross beams is such that forks of a forklift can be inserted into the pair of lateral beams or the pair of cross beams so as to grasp, retain and lift the tarping apparatus (i.e., the openings in the beams form forklift fork pockets). In the configuration shown, the beams are welded together to form the structure, however, other forms of attachment are contemplated. Additionally, while rectangular beams are shown, it is contemplated that other types of structures (such as those associated with pallet construction, for example) are contemplated. Additionally, other types of beams are contemplated, such as c-channels, i-beams, boxes formed from other materials such as wood and the like. Finally, composite structures are likewise contemplated.

The tarp support boom assembly 14 is shown in FIGS. 1 through 3 as comprising boom member 42, boom coupling member 40, and drum support assembly 44. As will be explained, the tarp support boom assembly 14 is coupled to the base frame 12, and extends both outwardly, and preferably upwardly, from the inner side 24 of the base frame 12. The boom coupling member 40 includes outer support 50 and inner support 52. The outer support 50 generally corresponds to the inner side 24 of the base frame, and generally extends upwardly therefrom. In the configuration shown, the outer support 50 extends substantially perpendicular to the cross beam 32a. The outer support 50 includes deflecting surface 54 (which may also form the stop for the tarp drum assembly in some configurations). That deflecting surface generally directs the tarp and precludes the tarp from extending therebeyond so as to begin wrapping around the base frame or the boom coupling member. The deflecting surface 54, in the configuration shown, includes front face 56, first wing face 57 and second wing face 58. The wing faces extend from the front face 56 in a direction away from the inner side 24, and are oblique to the front face 56.

The inner support 52 is spaced apart from the outer support 50 and from the inner side 24. The inner and outer supports are generally substantially perpendicular to the top surface of the base frame, and generally parallel to each other.

Each of the inner and outer supports of the boom coupling member include a region that is configured to receive and retain the boom member. In the configuration shown, each member includes an opening through which the boom member is directed, whereupon properly being positioned, the boom member is welded to the inner and outer supports. In other configurations, the inner and outer supports may include clamps which can couple the boom member thereto. In still other configurations, the boom member may include flanges with openings that correspond to openings on the boom coupling member (and/or on the base frame), and, fasteners can be utilized to join the two together.

The inner and outer supports are, in the configuration, welded to the top surface of the base frame, however, it is contemplated that such supports are otherwise fastened to the boom member and the base frame in any number of different manners. It is further contemplated that the inner and outer supports may be integrally formed with either one of the boom member and the base frame. In still further configurations, it is contemplated that a structure quite different and distinct from the inner and outer supports can be utilized to essentially join the base frame to the boom member. For example, the boom member may be directly welded to the base frame.

With continued reference to FIGS. 1 through 3, the boom member 42 comprises an elongated member having a proximal end 46 and a distal end 48. The boom member, in the configuration shown includes the boom as comprising a generally uniformly cylindrical member having a generally hollow cross-sectional configuration. Of course, other configurations are likewise contemplated, including different beam structures and the like, having varying cross-sectional configurations. The boom member is welded to both the inner and the outer supports at the proximal end 46. The relative positioning and attachment of the boom member is such that it is generally in a plane that is perpendicular to the inner side 24 (and in the configuration shown, generally parallel to the lateral sides 28, 29). Additionally, the boom member is oblique to the base frame, that is, the boom member extends upwardly from the base frame 12 such that the distal end 48 is above the proximal end 46. In the configuration shown, the angle α between the boom member and the horizontal is preferably between 1° and 45°, although a horizontal configuration (i.e., 0°) as well as an inclination in the opposing direction, and an angle greater than 45° is contemplated. Generally, the horizontal corresponds to the top surface and/or the bottom surface of the base frame. It will be understood that the boom member forms an axis of rotation of the drum member thereover, as will be explained below. The boom member, it is contemplated, may be between 10 and 25 feet long, depending on the application. Preferably, the boom member is long enough so as to accommodate a drum member and a tarp that is sized for the desired application (for example, a flatbed truck).

The drum support member 44 comprises outer support bearing surface 59. The bearing support surface provides a surface upon which the tarp drum assembly 16 can be positioned and about which it can rotate. In the configuration shown, the outer support bearing surface 59 comprises a member that can rotate relative to the boom member. In other configurations, the drum support member may include one or more bearings that are disposed along the length of the boom member. In other configurations, the boom member is allowed to rest on and rotate relative to the boom coupling member. Essentially, the boom member forms an axle for the tarp drum assembly, and it will be understood that a number of different drum support assemblies can be configured to engage therebetween.

The tarp drum assembly 16, as shown in FIGS. 1 through 3, includes drum member 60 and handle structure 70. The drum member includes first end 62 and second end 64. In the configuration shown, the drum member is substantially cylindrical in configuration with a central bore having a circular cross-sectional configuration. The drum member further includes an outer surface 68. In the configuration shown, the outer surface comprises a substantially uniformly cylindrical configuration. Of course, other configurations are contemplated, such as configurations with outer surface variations, with an outer surface that is other than cylindrical (such as square, star-like, among others). The particular configuration of the outer surface can be varied, with the understanding that the drum member is configured to rotate about the inner boom member. It will be understood that the drum member is slid over the boom member so that the first end of the drum member extends over the boom member toward the first end of the boom member. The second end of the drum member extends beyond the second end of the boom member. A stop flange or other barrier may be positioned along the inner bore 66 of the drum member so as to limit further extension of the drum member over the boom member.

The handle structure 70 is shown in FIGS. 1 through 3 as comprising moment arm 72 and handle 74. The moment arm 72, in the configuration shown, comprises a disk 76 that is fixedly coupled to the second end 64 of the drum member 60 so as to rotate in unison. The disk 76 includes inner surface 77 and outer surface 78. In the configuration shown, the disk 76 has a substantially circular configuration, defining an outer perimeter. The handle 74 is coupled to the disk 76 at a proximal end 80 and extending to a distal end 82. The handle 74 is generally perpendicular to the outer surface 78 of the disk 76, and generally parallel to and offset from the drum member. It will be understood that the handle structure 70 comprises a crank that is configured to allow the hand rotation of the drum member by grasping and cranking the handle and rotating the same about the boom member.

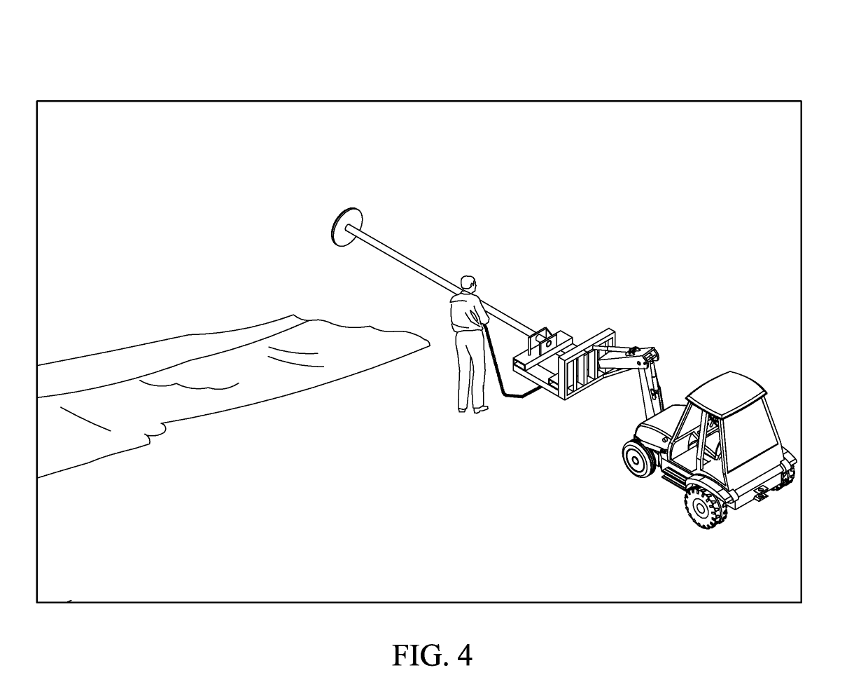

The operation of the tarping apparatus will be shown with reference to FIGS. 4 through 8. Specifically, in operation, the user prepares the tarping apparatus 10 for use. Generally, a forklift or the like is provided, and the forks thereof are directed through the forklift fork pockets created by either the lateral beams or by the cross beams. In fact, the rolling up and the unrolling can involve the capture by the forklift in a first pair of pockets and then in a second pair of pockets. The particular fork pockets that are used may be varied depending on the application and the configuration of the forks. As shown in FIG. 4, once inserted, the forks are typically lifted so as to lift the base frame off the ground. Generally, the apparatus is lifted so as to raise the boom member and the drum member to a height that allows for easier access by the user.

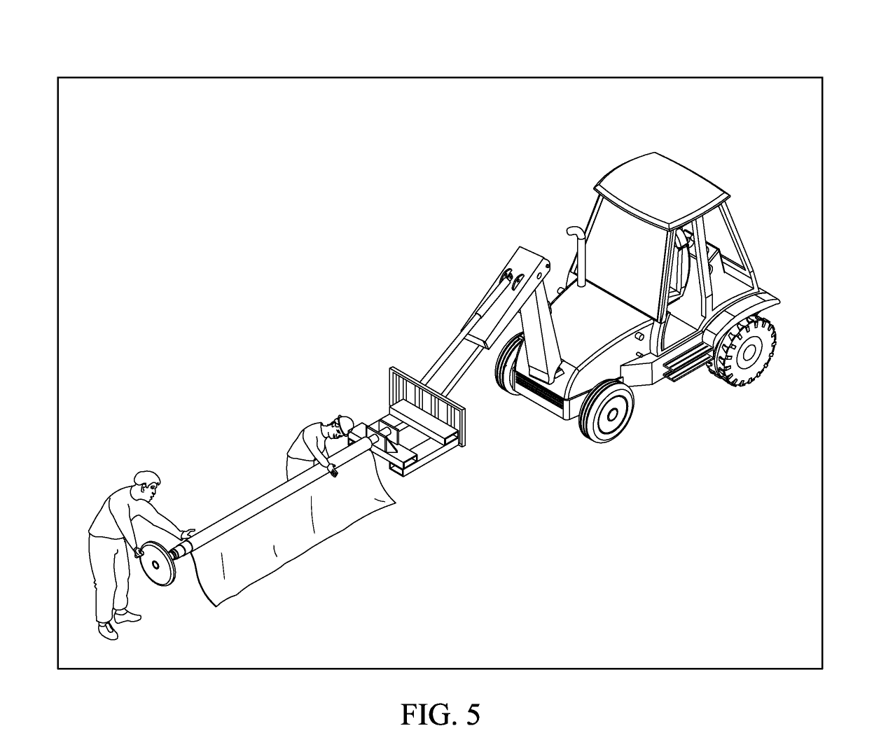

Also as shown in FIG. 4, the tarp is provided. The tarp generally includes a proximal end and a distal end. The proximal end is positioned over the drum member along the length thereof. The proximal end of the tarp can be releasably attached to the drum member, or can be held in place by the user. Once positioned, the drum member is rotated (preferably by rotating the drum member through rotation of the handle). With reference to FIG. 5, as the drum member is rotated, the tarp is taken and rolled up over the drum member. Generally, once the tarp is rolled over itself a couple of rotations, the tarp member generally does not slide relative to the drum member.

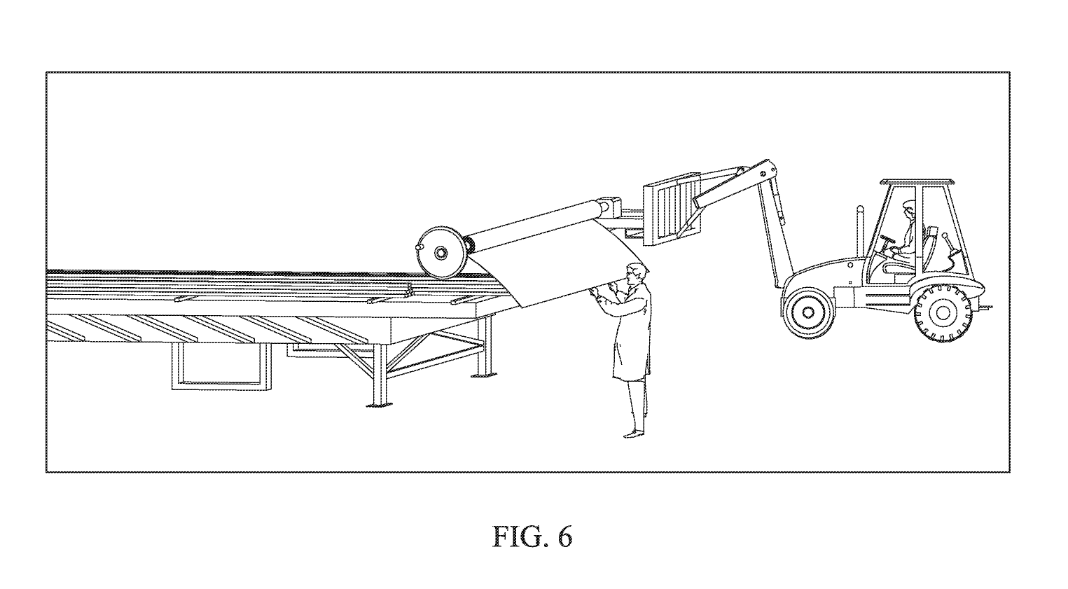

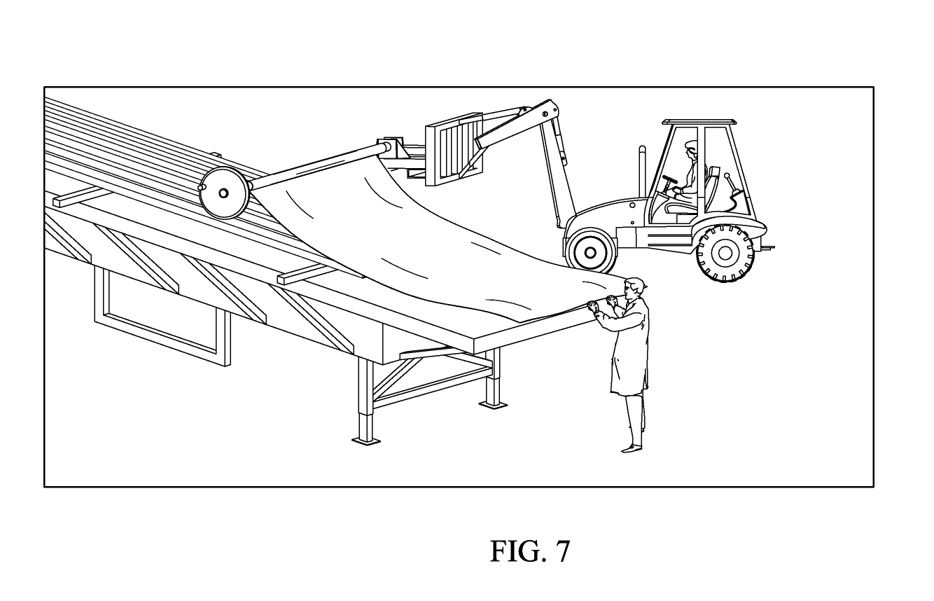

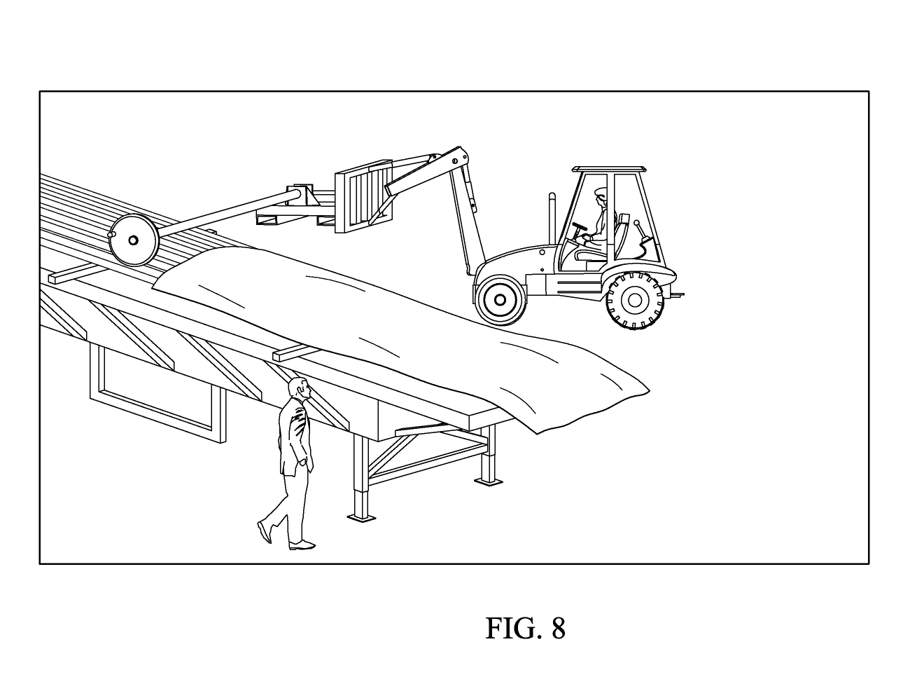

As shown in FIG. 6, once fully rolled up, the tarping apparatus is lifted over a flatbed of the semitrailer, and typically positioned over either the front or back end thereof. In particular, the position of the tarping apparatus is such that the drum member and the tarp are perpendicular to the length of the flatbed trailer. Next, the end of the tarp can be pulled away through rotation of the drum member, or can be held, all while the forklift directs the tarp apparatus toward the other end of the flatbed trailer (as shown in FIG. 7). As the forklift traverses along the side of the flatbed trailer, the drum member continues to rotate and unroll the tarp over the flatbed trailer. Eventually, as is shown in FIG. 8, the entirety of the tarp has been unrolled over the flatbed trailer.

The forklift can continue to move away from the flatbed trailer and can return and can grasp and retain another tarp for application to another flatbed trailer. It will be understood that depending on the load that is on the flatbed trailer, the forklift can vary the height that the tarping apparatus is raised off the ground to insure that the tarp drum assembly is raised over the flatbed trailer. It will be understood that the boom member is angled in an upward direction so that when the forklift lifts the tarping apparatus, and a tarp is rolled onto the drum member, even with the additional weight and movement, the boom member remains one of angled upwardly, or at least substantially horizontal. Preferably, it is not leaning in a downward direction.

It will be understood that variations in the operation are contemplated. In some embodiments, the tarping apparatus may be fixedly coupled to a vehicle, such as a truck or the like. In such a configuration, the truck itself may form the base frame, or a base frame may be permanently coupled thereto. In other configurations, the tarping apparatus may be fixed, with the flatbed trailer configured to move relative to the tarping apparatus. It will be understood that other variations are contemplated in the manner in which the tarping apparatus is moved relative to the flatbed trailer. It will further be understood that the tarping apparatus can be used to apply a tarp to a structure other than a flatbed trailer. For example, the tarping apparatus can be used to cover a stationary structure, or a structure on a different type of vehicle.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

1. A tarping apparatus comprising:
a base frame having an inner side and an outer side opposite the inner side;
a tarp support boom assembly including a boom member having a proximal end and a distal end, the proximal end is coupled to the base frame, and the distal end extends outwardly therefrom beyond the inner side of the base frame; and
a drum member extending around the boom member and rotatable about an axis defined by the boom member, the drum member including a first end corresponding to the proximal end of the boom member and a second end corresponding to the distal end of the boom member, whereupon a tarp positioned over the drum member can be rolled up on the drum member through rotation of the drum member relative to the boom member.

2. The tarping apparatus of claim 1 wherein the base frame further defines at least two fork pockets each configured to receive a fork of a forklift, to in turn, facilitate the lifting thereof.

3. The tarping apparatus of claim 2 wherein the at least two fork pockets are defined by a pair of at least one of lateral beams that are substantially parallel to each other and in a spaced apart configuration, and cross beams that are substantially parallel to each other and in a spaced apart configuration.

4. The tarping apparatus of claim 3 wherein the cross beams and the lateral beams are substantially perpendicular to each other.

5. The tarping apparatus of claim 1 wherein the boom member extends outwardly and upwardly relative to the base frame so that the proximal end is positioned lower than the distal end of the boom member.

6. The tarping apparatus of claim 5 wherein the base frame has a top surface defining a plane, with the boom member angled relative to the plane defined by the top surface of the base frame at an angle of between approximately 1° and approximately 45°.

7. The tarping apparatus of claim 1 wherein the tarp support boom assembly further includes a boom coupling member coupled to each of the boom member and the base frame, with the boom member extending outwardly therefrom, the boom coupling member including a deflecting surface extending proximate the inner side of the base frame, the deflecting surface configured to direct a tarp onto the drum member, and away from the base frame.

8. The tarping apparatus of claim 7 wherein the deflecting surface includes a front face from which the boom member extends, a first wing face extending to one side of the front face, and oblique thereto, and a second wing face extending to the other side of the front face, and oblique thereto.

9. The tarping apparatus of claim 1 wherein the drum member includes a first end that corresponds to the proximal end of the boom member, and a second end that extends beyond the distal end of the boom member.

10. The tarping apparatus of claim 9 wherein the tarp support boom assembly includes an outer support bearing surface positioned at the distal end of the boom member, the outer support bearing surface facilitating the rotation of the drum member relative to the boom member.

11. The tarping apparatus of claim 1 further including a handle structure coupled to the second end of the drum member, the handle structure including a moment arm a component of which extends substantially perpendicular to the drum member, and having an outer end, and a handle coupled to the outer end of the moment arm, whereupon rotation of the handle member about the axis defined by the boom member rotates the drum member around the boom member.

12. The tarping apparatus of claim 11 wherein the moment arm comprises a disk coupled to the second end of the drum member, the disk including an inner surface and an outer surface, with an outer perimeter corresponding to the outer end, the handle coupled to the outer perimeter of the moment arm.

13. The tarping apparatus of claim 1 wherein the boom member has a substantially cylindrical configuration, with a substantially circular cross-sectional configuration.

14. The tarping apparatus of claim 12 wherein the drum member has a substantially cylindrical configuration, with a substantially circular cross-sectional configuration.

15. A method of tarping an outside structure such as a flatbed comprising the steps of:
providing a tarping apparatus comprising:
a base frame;
a tarp support boom assembly including a boom member extending away from the base frame, and coupled thereto;
a drum member extending about the boom member, and rotatable about the boom member;
providing a tarp having a proximal end and a distal end;
positioning the proximal end of the tarp on the drum member;
rotating the drum member so as to roll the tarp thereon until the distal end at least approaches the drum member;
positioning the tarping apparatus relative to the outside structure, so that the drum member overlies the outside structure;
retaining the distal end of the tarp proximate an end of the outside structure;
directing the tarping assembly along the outside structure, with the drum member traversing the outside structure; and
rotating the drum member to, in turn, unroll the tarp onto the outside structure.

16. The method of tarping of claim 15 wherein the drum member is positioned so as to be substantially perpendicular to a direction of travel of the tarping apparatus.

17. The method of tarping of claim 15 further including the steps of:
providing a forklift; and
coupling the base frame to a forklift.

18. The method of claim 17 wherein the step of positioning the tarping apparatus relative to the outside structure further comprises the step of:
moving the forklift to a location proximate the outside structure.

19. The method of claim 18 wherein the step of directing the tarping assembly along the outside structure further comprises the step of:
moving the forklift relative to the outside structure.
